(19) United States
(12) Patent Application Publication
(10) Pub. No.: US 2015/0274979 A1
(43) Pub. Date: Oct. 1, 2015

(54) MULTI-LAYER FIBER COATINGS

(71) Applicant: Rolls-Royce Corporation, Indianapolis, IN (US)

(72) Inventor: Andrew J. Lazur, Huntington Beach, CA (US)

(21) Appl. No.: 14/207,030

(22) Filed: Mar. 12, 2014

Related U.S. Application Data
(60) Provisional application No. 61/783,845, filed on Mar. 14, 2013.

(51) Int. Cl. C09D 1/00; D06M 11/77; D06M 11/80; D06M 11/74; D06M 11/58

(52) U.S. Cl. CPC C09D 1/00; D06M 11/74; D06M 11/58; D06M 11/80; D06M 11/77

(57) ABSTRACT

A multi-layer fiber coating is provided which, in an illustrative embodiment, includes: a ceramic grade Nicalon preform; a silicon carbide coat applied over the fibers; a boron nitride interface coat applied over the silicon carbide coat; wherein the boron nitride coat has a thickness of about 0.5 μm; a silicon carbide coat applied over the boron nitride coat; and wherein the silicon carbide has a thickness of about 2 μm.

### RELATED APPLICATIONS

This application is related to and claims priority to U.S. Provisional Patent Application Ser. No. 61/783,845 filed on Mar. 14, 2013 entitled “Multi-Layer Fiber Coating.” The subject matter disclosed in that provisional application is hereby expressly incorporated into the present application in its entirety.

### FIELD OF THE DISCLOSURE

The present disclosure relates to multi-layer fiber coatings, and particularly to multi-layer fiber coatings for ceramic fiber applications.

### BACKGROUND

Economical and environmental concerns, i.e. improving efficiency and reducing emissions, are driving forces behind the ever increasing demand for higher gas turbine inlet temperatures. A limitation to the efficiency and emissions of many gas turbine engines is the temperature capability of hot section components such as blades, vanes, blade tracks, and combustor liners. Technology improvements in cooling, materials, and coatings are required to achieve higher inlet temperatures. As the temperature capability of Ni-based superalloys has approached their intrinsic limit, further improvements in their temperature capability have become increasingly difficult. Therefore, the emphasis in gas turbine materials development has shifted to thermal barrier coatings (TBC) and next generation high temperature materials, such as ceramic-based materials.

Silicon Carbide/Silicon Carbide (SiC/SiC) Ceramic Material Composite (CMC) materials are prime candidates to replace Ni-based superalloys for hot section structural components for next generation gas turbine engines. The key benefit of SiC/SiC CMC engine components is their excellent high temperature mechanical, physical, and chemical properties which allow gas turbine engines to operate at much higher temperatures than the current engines having superalloy components. SiC/SiC CMCs also provide the additional benefit of damage tolerance, which monolithic ceramics do not possess.

### SUMMARY

The present disclosure includes a multi-layer fiber coatings for ceramic fiber applications.

An illustrative embodiment of the present disclosure provides a multi-layer fiber coating which comprises: a ceramic grade Nicalon preform; a silicon carbide coat applied over the fibers; wherein the silicon carbide coat has a thickness of about 1 μm; a boron nitride interface coat applied over the silicon carbide coat; wherein the boron nitride coat has a thickness of about 0.5 μm; a silicon carbide coat applied over the boron nitride coat; and wherein the silicon carbide has a thickness of about 2 μm.

In the above and other embodiments, the multi-layer fiber coating may further comprise: the Nicalon preform including about 36% fiber volume; the Nicalon preform being assembled in a tooling for chemical vapor infiltration; the silicon carbide coat having an effective fiber volume of about 39%; the Nicalon preform being cleaned using air at about 600 degrees C. to remove sizing char; the preform being completed with slurry and melt infiltration; the 1 μm of silicon carbide being applied by chemical vapor infiltration; the 2 μm of silicon carbide being applied by chemical vapor infiltration.

Another illustrative embodiment of the present disclosure provides a multi-layer fiber coating which comprises: a Tyranno Lox-M fiber coated in tow form with 1 μm of silicon carbide by a chemical vapor deposition process and about 1 μm of silicon nitride; a silicon doped boron nitride coat is applied over the about 1 μm of silicon nitride; and wherein the doped boron nitride coat has a thickness of 0.3 μm.

In the above and other embodiments, the multi-layer fiber coating may further comprise: the Tyranno Lox-M fiber in the tow being coated with silicon nitride of about 0.3 μm and silicon carbide of about 0.1 μm; the tow being processed with a silicon carbide slurry and binders to form a uni-directional tape; the tapes being laminated and shaped, then cured; and a resulting body that is infiltrated with silicon to complete the CMC component.

Another illustrative embodiment of the present disclosure provides a multi-layer fiber coating which comprises: a T-300 carbon fiber preform; a coat that is graded from PyC to SiC is applied over the T-300 carbon fiber preform; wherein the graded PyC to SiC coat has a thickness of about 1.5 μm; a silicon doped boron nitride interface coat is applied over the graded PyC to SiC coat; wherein the silicon doped boron nitride interface coat has a thickness of about 0.5 μm; and a silicon carbide coat of 2 μm is applied over the silicon doped boron nitride interface coat.

In the above and other embodiments, the multi-layer fiber coating may further comprise: the T-300 carbon fiber preform includes about 36% fiber volume; the T-300 carbon fiber preform is assembled in tooling for chemical vapor infiltration; a silicon nitride coat of about 0.2 μm being applied over the silicon carbide coat; the graded PyC to SiC coat being applied by chemical vapor infiltration; the silicon carbide coating of 2 μm being applied by chemical vapor infiltration; and the silicon nitride coat of 0.2 μm being applied by chemical vapor infiltration.

It should be appreciated that the present application discloses one or more of the features recited in the appended claims and/or the following features which alone or in any combination may comprise patentable subject matter.

### BRIEF DESCRIPTION OF THE DRAWINGS

FIG. 1 is a flow diagram showing a multi-layer process according to the present disclosure; and

FIG. 2 is an end view of ceramic fibers showing an “improved” multi-layer coating.

### DETAILED DESCRIPTION

The present disclosure includes a fiber coating that incorporates at least one layer prior to the fiber interface coating to improve chemical compatibility of the fiber and interface coating. Illustratively, the first coating is bonded to the fiber and is followed by an interface coating and optionally additional coatings. The coating may be a slightly altered composition of the fiber or a totally different composition. The coating acts as barrier between incompatible elements.

The coating may also “heal” surface flaws on the fiber and to increase the effective fiber volume by increasing the diameter of the fiber. The coating may be uniform in composition and structure, graded intentionally to produce a better match between the fiber and the interface coating or consist of multiple thin layers prior to the interface coating. The coating may be followed by other functional coatings prior to the interface coating to improve structural performance or environmental resistance.

The coating may range from 0.01 μm to 2 μm, and may be deposited by chemical vapor deposition, physical vapor deposition (including directed vapor deposition) or other suitable means. The fiber in the composite may be carbon, ceramic (silicon carbide, alumina, aluminosilicate, SiNC etc.) or glass. The coating (or coating layers) may consist of elemental, binary or ternary compounds of the following elements: carbon, nitrogen, oxygen, silicon, germanium, boron, aluminum, titanium, zirconium, hafnium, vanadium, niobium, tantalum, chromium, molybdenum, nickel, scandium, yttrium, ytterbium and rhenium.

Illustratively, it may be desirable to tailor the coating composition and/or structure to produce a slightly lower modulus than the fiber to reduce stress in the coating layer and delay surface cracking.

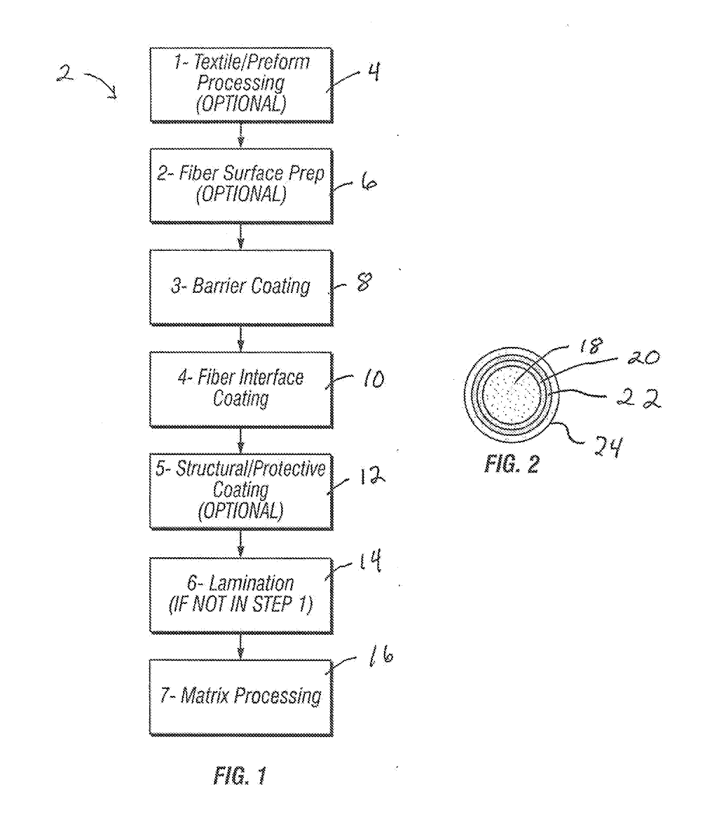

A flow diagram depicting a process 2 of applying a barrier coating on a fiber is shown in FIG. 1. The first step of process 2 is providing the fiber material, textile, or preform, for processing at 4. Illustratively, the fiber surface may be prepared by cleaning it using high temperature air to remove sizing char at 6. A barrier coating is then applied over the fiber at 8. This barrier coating may be a silicon carbide coating applied by chemical vapor infiltration, for example. Over the barrier coating, the fiber interface coating is supplied at 10. Such an interface coating may include boron nitride. A structural and protective coating 12 may be applied over interface coating 10. The structural coating may be silicon carbide applied by chemical vapor infiltration. Optionally, additional fiber layers may be applied at 14 after the structural coating if not already done in step 1 of process 2. Lastly, a CMC matrix may be completed with slurry and melt infiltration at 16.

An end sectional view of fiber material 18 is shown in FIG. 2. A barrier coating 20 such as that described with respect to step 8 in FIG. 1 is applied over top of fiber 18. An interface coating 22 is applied over the barrier coating. Lastly, the structural protective layer coating 24 is applied on top pursuant step 12 of process 2.

Advantages of this multi-layer coating may include: enabling use of lower cost fibers with oxygen sensitive interface coatings like boron nitride; reducing or eliminating damage to fiber surfaces during interface coating deposition (e.g. incompatibility of carbon and BN deposition); the additional layer providing an opportunity to manage thermal and mechanical incompatibilities between a fiber an subsequent coatings and additional oxidation resistance to the fiber; increasing ultimate strength resulting from surface defect reduction; and increasing creep strength if the fiber coating has higher creep capability than the fiber.

The following are non-limiting illustrative embodiments of a barrier coating:

### Preform Based CMC

1. A ceramic grade Nicalon preform constructed of 36% fiber volume and assembled in tooling for chemical vapor infiltration (CVI);

2. the preform is cleaned using air at 600 degrees C. to remove sizing char from the fiber;

3. the fiber is coated with 1 μm of silicon carbide (SiC) by CV, the effective fiber volume is now close to 39%;

4. a boron nitride (BN) interface coating is then applied at 0.5 μm;

5. a SiC coating of 2 μm is applied by CVI; and

6. the CMC matrix is completed with slurry and melt infiltration.

It is notable that the interface coating remains functional as a result of limited, if any, interaction with oxygen in the fiber.

### CMC Made with Pre-Coated Fiber

1. Tyranno Lox-M fiber is coated in tow form with 1 μm of SiC by a chemical vapor deposition (CVD) process, and 1 μm of silicon nitride;

2. a subsequent process applies a silicon doped boron nitride coating of 0.3 μm;

3. the fiber in the tow is coated with silicon nitride of 0.3 μm and silicon carbide of 0.1 μm;

4. the tow is processed with a SiC slurry and binders to form a tape;

5. the tapes are laminated and shaped then cured; and

6. the resulting body is infiltrated with silicon to complete the CMC component.

Again, the interface coating remains functional as a result of limited if any interaction with oxygen in the fiber.

### Preform Based CMC II

1. A T-300 carbon fiber preform is constructed of 36% fiber volume and assembled in tooling for CVI;

2. the fiber is coated with a layer that is graded from PyC to SiC over 1.5 μm by CVI;

3. a silicon doped boron nitride (BN) interface coating of 0.5 μm is applied;

4. a SiC coating of 2 μm is then applied by CVI; [correct?]

5. a silicon nitride coating of 0.2 μm is applied by CVI; and

6. the CMC matrix is completed through slurry and melt infiltration.

The resulting composite has an interface coating with improved oxidation resistance compared to the typical PyC coating and the fiber remains undamaged from the BN deposition process.

While the disclosure has been described in this detailed description, the same is to be considered as exemplary and not restrictive in character, it being understood that only illustrative embodiments thereof have been described and that changes and modifications that come within the spirit of the disclosure are desired to be protected.

What is claimed is:

1. A multi-layer fiber coating, comprising:
a ceramic grade Nicalon preform;
a silicon carbide coat applied over the fibers;
wherein the silicon carbide coat has a thickness of about 1 μm;
a boron nitride interface coat applied over the silicon carbide coat;
wherein the boron nitride coat has a thickness of about 0.5 μm;
a silicon carbide coat applied over the boron nitride coat; and
wherein the silicon carbide has a thickness of about 2 μm.

2. The multi-layer fiber coating of claim 1, wherein the Nicalon preform includes about 36% fiber volume.

3. The multi-layer fiber coating of claim 2, wherein the Nicalon preform is assembled in a tooling for chemical vapor infiltration.

4. The multi-layer fiber coating of claim 1, wherein the silicon carbide coat has an effective fiber volume of about 39%.

5. The multi-layer fiber coating of claim 2, wherein the Nicalon preform is cleaned using air at about 600 degrees C. to remove sizing char.

6. The multi-layer fiber coating of claim 1, wherein the preform is completed with slurry and melt infiltration.

7. The multi-layer fiber coating of claim 1, wherein the 1 μm of silicon carbide is applied by chemical vapor infiltration.

8. The multi-layer fiber coating of claim 1, wherein the 2 μm of silicon carbide is applied by chemical vapor infiltration.

9. A multi-layer fiber coating, comprising:
a Tyranno Lox-M fiber coated in tow form with 1 μm of silicon carbide by a chemical vapor deposition process and about 1 μm of silicon nitride;
a silicon doped boron nitride coat is applied over the about 1 μm of silicon nitride; and
wherein the doped boron nitride coat has a thickness of 0.3 μm.

10. The multi-layer fiber coating of claim 9, wherein the Tyranno Lox-M fiber in the tow is coated with silicon nitride of about 0.3 μm and silicon carbide of about 0.1 μm.

11. The multi-layer fiber coating of claim 9, wherein the tow is processed with a silicon carbide slurry and binders to form a uni-directional tape.

12. The multi-layer fiber coating of claim 9, wherein the tapes are laminated and shaped, then cured.

13. The multi-layer fiber coating of claim 9, wherein a resulting body is infiltrated with silicon to complete the CMC component.

14. A multi-layer fiber coating, comprising:
a T-300 carbon fiber preform;
a coat that is graded from PyC to SiC is applied over the T-300 carbon fiber preform;
wherein the graded PyC to SiC coat has a thickness of about 1.5 μm;
a silicon doped boron nitride interface coat is applied over the graded PyC to SiC coat;
wherein the silicon doped boron nitride interface coat has a thickness of about 0.5 μm; and
a silicon carbide coat of 2 μm is applied over the silicon doped boron nitride interface coat.

15. The multi-layer fiber coating of claim 14, wherein the T-300 carbon fiber preform includes about 36% fiber volume.

16. The multi-layer fiber coating of claim 14, wherein the T-300 carbon fiber preform is assembled in tooling for chemical vapor infiltration.

17. The multi-layer fiber coating of claim 14, further comprising a silicon nitride coat of about 0.2 μm is applied over the silicon carbide coat.

18. The multi-layer fiber coating of claim 14, wherein the graded PyC to SiC coat is applied by chemical vapor infiltration.

19. The multi-layer fiber coating of claim 14, wherein the silicon carbide coating of 2 μm is applied by chemical vapor infiltration.

20. The multi-layer fiber coating of claim 14, wherein the silicon nitride coat of 0.2 μm is applied by chemical vapor infiltration.
